(19) United States
(12) Patent Application Publication
(10) Pub. No.: US 2011/0296455 A1
(43) Pub. Date: Dec. 1, 2011

(54) MOVING PICTURE PROVIDING SYSTEM FOR PROVIDING DYNAMIC ADVERTISEMENT VARYING ACCORDING TO TIMES

(75) Inventors: Dong-Sik LEE, Ansan-si (KR); Bo-Ram Lee, Seoul (KR)

(73) Assignee: SOLSPECTRUM Co., Ltd., Seoul (KR)

(21) Appl. No.: 13/093,953

(22) Filed: Apr. 26, 2011

(30) Foreign Application Priority Data
May 31, 2010 (KR) 10-2010-0051358

(51) Int. Cl. H04N 7/025

(52) U.S. Cl. 725/32

(57) ABSTRACT

A moving picture providing system for providing a dynamic advertisement varying according to times is provided. The moving picture providing system determines an advertisement priority that varies according to times for each of frames that constitute a moving picture in consideration of a user selection factor for each frame and an advertisement selection factor for each frame, selects at least one frame to which an advertisement is to be applied according the determined advertisement priority, and provides a moving picture by applying the advertisement to the selected at least one frame. At the beginning of a selecting of advertisements to be included in a moving picture, an advertisement is selected more based on moving picture originated information than user preference information but the ratio of advertisement selection based on user preference information is getting larger with the time lapse. A moving picture having an increasing ratio of a user adaptive advertisement is provided, so that the efficiency of the advertisement is enhanced.

### CROSS-REFERENCE TO RELATED APPLICATION

This application claims the benefit under 35 U.S.C. §119(a) of Korean Patent Application No. 10-2010-0051358, filed on May 31, 2010, the disclosure of which is incorporated by reference in its entirety for all purposes.

### BACKGROUND

1. Field

The following description relates to a moving picture providing technique, and more particularly, to a system for providing a moving picture having an advertisement.

2. Description of the Related Art

In providing a moving picture having an advertisement, the advertisement is selected by use of characters and dialogs that are acquirable in a moving picture, so the preference by a user is not reflected in the advertisement.

Accordingly, there is a need for enhancement of the efficiency of the advertisement through providing a moving picture having a user adaptive advertisement which is selected according to user preference information that is accumulated and varies according to times.

### SUMMARY

In one aspect, there is provided a moving picture providing system for providing a dynamic advertisement varying according to times, in which, at the beginning of a selecting of advertisements to be included in a moving picture, an advertisement is selected more based on moving picture originated information than user preference information, but the ratio of advertisement selection based on user preference information is getting larger with the time lapse.

In one general aspect, there is provided a moving picture providing system. The moving picture providing system determines an advertisement priority of moving picture frames, which varies according to times, in consideration of a user selection factor for each frame and an advertisement selection factor for each frame, selects at least one frame to which an advertisement is to be applied according the determined advertisement priority, and provides a moving picture by applying the advertisement to the selected at least one frame.

As described above, at the beginning of a selecting of advertisements to be included in a moving picture, an advertisement is selected more based on moving picture originated information than user preference information but the ratio of advertisement selection based on user preference information is getting larger with the time lapse. Accordingly, a moving picture having an increasing ratio of a user adaptive advertisement is provided, so that the efficiency of the advertisement is enhanced.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a block diagram showing an example of a moving picture providing system for providing a dynamic advertisement varying according to times.

FIG. 2 is a graph showing that the ratio of advertisement selection based on the user preference information is increased according to times in selecting advertisements that are to be included in a moving picture.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

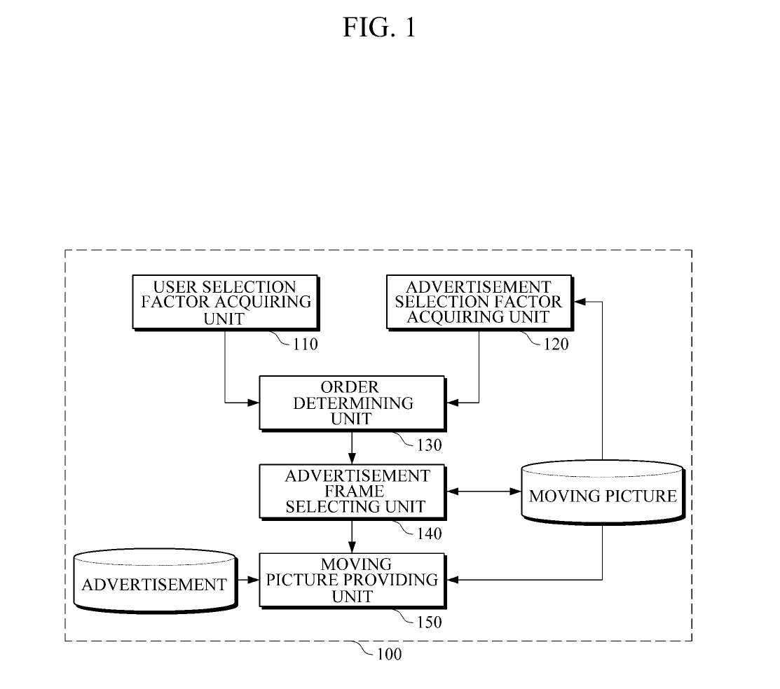

FIG. 1 is a block diagram showing an example of a moving picture providing system for providing a dynamic advertisement varying according to times. As shown in FIG. 1, an example of a moving picture providing system 100 for providing a dynamic advertisement varying according to times includes a user selection factor acquiring unit 110, an advertisement selection factor acquiring unit 120, an order determining unit 130, an advertisement frame selecting unit 140 and a moving picture proving unit 150.

The user selection factor acquiring unit 110 acquires a user selection factor for each of frames that constitute a moving picture. For example, the user selection factor may represent the number of replies generated by users for each of image frames that constitute a moving picture or may represent the number of captures performed by users for each of image frames that constitute a moving picture. In this case, the number of replies or the number of captures for each image frame may represent the preference by a user.

For example, in the case that the user selection factor is the number of replies generated by users for each of image frames constituting a moving picture, the user selection factor acquiring unit 110 is connected to a message board (not shown) available to post a user reply for each image frame constituting a moving picture, and search the number of user replies for each image frame, thereby acquiring the user selection factor.

For example, in the case that the user selection factor is the number of captures made by users for each of image frames that constitute a moving picture, the user selection factor acquiring unit 110 is connected to a private web folder (not shown) that stores images captured from a predetermine image frame of a moving picture, and calculates the number of image captures for each image frame, thereby acquiring the user selection factor.

The advertisement selection factor acquiring unit 120 acquires the advertisement selection factor from each of frames constituting a moving picture. For example, the advertisement selection factor may be a predetermined object that is recognized from each of image frame screens constituting a moving picture, a predetermined speech that is recognized from each of speech frames constituting a moving picture or a predetermined text that is recognized from sub-titles included in each of image frame screens constituting a moving picture.

The predetermined object recognized from each image frame screen constituting a moving picture may represent an identifiable object including characters, animals or stuffs, such as vehicles, appearing in the moving picture. The predetermined object may be recognized through various types of image recognition schemes that are generally known in the art.

The predetermined speech recognized from each speech frame constituting a moving picture may represent an identifiable speech corresponding to the name of characters, the name of animal or the name of stuff. The predetermined speech may be recognized through various types of speech recognition schemes that are generally known in the art.

The predetermined text recognized from sub-titles included in each image frame screen constituting a moving picture may represent an identifiable text corresponding to the name of characters, the name of animal or the name of stuff. The predetermined text may be recognized through various types of text recognition schemes that are generally known in the art.

The order determining unit 130 determines an advertisement priority of the frames, which varies according to times, in consideration of the user selection factor, which is acquired by the user selection factor acquiring unit 110, and the advertisement selection factor, which is acquired by the advertisement selection factor acquiring unit 120.

For example, in the case that the advertisement selection factor is a predetermined object that is recognized from each image frame screen constituting a moving picture, the order determining unit 130 assigns a higher advertisement priority to a series of image frames in which the predetermined object is continuously shown.

For example, in the case that the advertisement selection factor is a predetermined speech that is recognized from each speech frame constituting a moving picture, the order determining unit 130 assigns a higher advertisement priority to speech frames in which the predetermined speech is included.

For example, in the case that the advertisement selection factor is a predetermined text that is recognized from sub-titles included in each image frame screen constituting a moving picture, the order determining unit 130 assigns a higher advertisement priority to image frames in which the predetermined text is included.

The advertisement frame selecting unit 140 selects at least one frame, to which an advertisement is to be applied, according the time variant advertisement priority that is determined by the order determining unit 130.

That is, the advertisement frame selecting unit 140 selects at least one frame having a higher advertisement priority that is determined by the order determining unit 130 as a frame to which an advertisement is to be applied. Since the advertisement priority varies according to the user selection factor with the lapse of time, the advertisement frame selecting unit may dynamically select at least one frame, to which an advertisement is applied, according to times.

The moving picture image providing unit 150 provides the moving picture by applying an advertisement to the at least one frame that is selected by the advertisement frame selecting unit 140. In this manner, at the beginning of a selecting of advertisements to be included in a moving picture, an advertisement is selected more based on moving picture originated information than user preference information, but the ratio of advertisement selection based on user preference information is getting larger with the time lapse. Accordingly, as time goes by, a moving picture having an increasing ratio of a user adaptive advertisement is provided, so that the efficiency of the advertisement is enhanced.

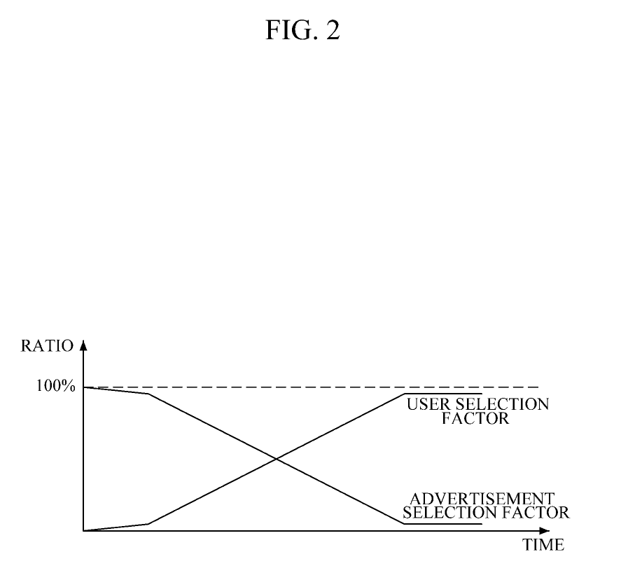

FIG. 2 is a graph showing that the ratio of advertisement selection based on the user preference information is increased according to times in selecting advertisements that are to be included in a moving picture. As shown in FIG. 2, at the beginning of providing a moving picture, the portion of advertisement selection based on moving picture originated information is more than that of advertisement selection based on user preference information but the ratio of user adaptive advertisement is getting larger with the time lapse.

According to another example, the order determining unit 130 determines the advertisement priority of frames of a moving picture, which varies according to times, by assigning weights to the user selection factor and the advertisement selection factor, respectively.

For example, if the number of the user selection factor (denoted as a) indicating the preference by a user is m and the number of the advertisement selection factor (denoted as b) that is acquirable from a moving picture is n, the order determining unit 130 may determine an advertisement priority (denoted as f) of each frame, which varies according to times, through equation 1 below.

$$f = {{Q}^{m}}_{i = 0} {w}_{i} {a}_{i} + {{Q}^{n}}_{j = 0} {u}_{j} {b}_{j} \qquad [ Equation 1 ]$$

In this equation, w represents the weight of the user selection factor a, and u represents the weight of the advertisement selection factor b. Since the value of the user selection factor a is getting increased according to times, and the value of the advertisement selection factor b is constant, an advertisement priority determining value is getting more dependent of the user selection factor according to times.

As described above, at the beginning of a selecting of advertisements to be included in a moving picture, an advertisement is selected more based on moving picture originated information than user preference information, but the ratio of advertisement selection based on user preference information is getting larger with the time lapse. Accordingly, a moving picture having an increasing ratio of a user adaptive advertisement according to times is provided, and the efficiency of an advertisement is enhanced.

Although an exemplary embodiment of the present invention has been described for illustrative purposes, those skilled in the art will appreciate that various modifications, additions and substitutions are possible, without departing from the scope and spirit of the invention as disclosed in the accompanying claims

What is claimed is:

1. A moving picture providing system for providing a dynamic advertisement varying according to times, the system comprising:
a user selection factor acquiring unit configured to acquire a user selection factor for each of frames that constitute a moving picture;
an advertisement selection factor acquiring unit configured to acquire an advertisement selection factor from the each of the frames that constitute the moving picture;
an order determining unit configured to determine an advertisement priority of the frames, which varies according to times, in consideration of the user selection factor, which is acquired by the user selection factor acquiring unit, and the advertisement selection factor, which is acquired by the advertisement selection factor acquiring unit;
an advertisement frame selecting unit configured to select at least one frame, to which an advertisement is to be applied, according the determined advertisement priority that varies according to times; and
a moving picture providing unit configured to provide the moving picture by applying the advertisement to the at least one frame that is selected by the advertisement frame selecting unit.

2. The system of claim 1, wherein the order determining unit determines the advertisement priority of the frames, which varies according to times, by assigning weights to the user selection factor and the advertisement selection factor, respectively.

3. The system of claim 1, wherein the user selection factor represents the number of replies generated by users for each of image frames that constitute the moving picture.

4. The system of claim 1, wherein the user selection factor represents the number of captures performed by users for each of image frames that constitute the moving picture.

5. The system of claim 1, wherein the advertisement selection factor represents a predetermined object that is recognized from each of image frame screens that constitute the moving picture.

6. The system of claim 5, wherein the order determining unit assigns a higher advertisement priority to a series of image frames in which the predetermined object is continuously shown.

7. The system of claim 1, wherein the advertisement selection factor represents a predetermined speech that is recognized from each of speech frames that constitute the moving picture.

8. The system of claim 7, wherein the order determining unit assigns a higher advertisement priority to speech frames in which the predetermined speech is included.

9. The system of claim 1, wherein the advertisement selection factor represents a predetermined text that is recognized from sub-titles included in each of image frame screens that constitute the moving picture.

10. The system of claim 9, wherein the order determining unit assigns a higher advertisement priority to image frames in which the predetermined text is included.
